(19) United States
(12) Patent Application Publication
(10) Pub. No.: US 2026/0139793 A1
(43) Pub. Date: May 21, 2026

(54) BRACKET SUPPORT

(71) Applicant: Caffeinated Creations LLC, Westerville, OH (US)

(72) Inventor: Adam D. Coffey, Westerville, OH (US)

(21) Appl. No.: 19/394,854

(22) Filed: Nov. 19, 2025

Related U.S. Application Data
(60) Provisional application No. 63/722,155, filed on Nov. 19, 2024.

(51) Int. Cl. F16M 13/02

(52) U.S. Cl. CPC F16M 13/02

(57) ABSTRACT

In some embodiments, a mounting bracket for mounting an L-shaped bracket of a curtain rod to a wall includes a base plate with a flat rear surface for wall mounting and a front surface for receiving a curtain rod end. The base plate includes first and second upper extending tabs with angled holes for screws, defined by outwardly and upwardly extending angled cylinders. A bottom portion defines third and fourth angled holes for screws, defined by outwardly and downwardly extending cylinders. An elongated channel structure on the front surface defines a vertical slot to receive and support an L-shaped curtain rod bracket. First and second vertical extending tabs are positioned at each side of the channel structure. The mounting bracket may include a snap-on facial cover mirroring the base plate's front side, concealing the channel structure and holes.

### CROSS-REFERENCE TO RELATED APPLICATIONS

This application claims priority to U.S. Provisional Application No. 63/722,155, titled BRACKET SUPPORT, filed Nov. 19, 2024, which is hereby incorporated by reference in its entirety.

### FIELD OF INVENTION

The present disclosure relates to mounting hardware for supporting curtain rods or shelving, and more particularly to a mounting bracket with angled fastening holes and a vertical slot configured to receive and secure L-shaped brackets.

### BACKGROUND

Mounting brackets for curtain rods and shelving systems have been utilized for decades to provide wall-mounted support for window treatments and storage solutions. Traditional mounting brackets typically comprise a base plate that attaches to a wall surface and an extending arm or support structure that holds the curtain rod or shelf bracket. These conventional systems generally rely on standard mounting holes positioned perpendicular to the wall surface, with fasteners inserted straight into the wall to secure the bracket in place.

Current mounting bracket systems face several limitations related to their structural stability and load-bearing capacity. The perpendicular orientation of traditional mounting holes can result in fasteners being subjected primarily to pull-out forces when the bracket experiences loading from the supported curtain rod or shelf. This configuration may lead to gradual loosening of the fasteners over time, particularly when supporting heavier curtain assemblies or loaded shelves. The reliance on straight-in fastening approaches can limit the holding power of the mounting system, especially in drywall or other hollow wall construction.

Another challenge with existing mounting brackets relates to their installation complexity and alignment accuracy. Many conventional systems require precise positioning and leveling of multiple brackets to ensure proper support of curtain rods or shelving systems. The installation process often involves measuring, marking, and drilling multiple holes while maintaining proper spacing and alignment between brackets. This can be time-consuming and may result in installation errors that affect the functionality and appearance of the final assembly.

Additionally, conventional mounting brackets may lack versatility in accommodating different types of curtain rod supports or shelf brackets. Many existing designs are configured for specific bracket types or rod diameters, limiting their applicability across different window treatment or shelving systems. The fixed nature of many bracket designs can also make it difficult to adjust or reposition the supported elements after installation.

It has been appreciated that a mounting bracket system is needed that overcomes one or more of these problems.

### SUMMARY

This Summary is provided to introduce a selection of concepts in a simplified form that are further described below in the Detailed Description.

The presently disclosed subject matter is directed to a mounting bracket comprising a base plate having a rear surface for mounting to a wall and a front surface, first and second upper extending tabs extending from an upper portion of the base plate, the first and second upper extending tabs defining first and second angled holes oriented at downward angles for receiving fasteners, a bottom portion of the base plate defining third and fourth angled holes oriented at upward angles for receiving fasteners, and a vertical slot formed in the base plate and configured to receive and support an L-shaped bracket. The angled configuration of the fastening holes creates opposing force vectors that generate a pinching action, providing enhanced stability and load distribution compared to conventional perpendicular fastening methods. The vertical slot accommodates various L-shaped bracket geometries commonly used in curtain rod and shelving applications while maintaining secure retention during operational loading.

In some embodiments, the first and second angled holes are defined by first and second angled cylinders extending outwardly and upwardly from the front surface, and the third and fourth angled holes are defined by third and fourth angled cylinders extending outwardly and downwardly from the front surface. The cylindrical structure provides reinforced mounting points and bearing surfaces for fasteners while directing the fasteners at predetermined angles to create the pinching action that secures the mounting bracket to the mounting surface.

In some embodiments, the mounting bracket further comprises first and second reinforcement tabs integrated with the front surface and positioned at opposite sides of the vertical slot. The reinforcement tabs provide additional structural support to the vertical slot assembly and distribute applied loads across the base plate structure, enhancing the overall rigidity and load-bearing capacity of the mounting bracket.

In some embodiments, the first, second, third, and fourth angled holes are oriented at angles between 15 degrees and 45 degrees from perpendicular to the rear surface. This angular range provides optimal balance between withdrawal resistance and lateral stability for different wall materials and loading conditions, with angles closer to 15 degrees providing increased withdrawal resistance for softer materials and angles approaching 45 degrees providing enhanced lateral stability for harder materials.

In some embodiments, the mounting bracket further comprises an elongated arch structure attached to the front surface and defining the vertical slot. The elongated arch structure provides structural boundaries for the vertical slot and transfers loads applied by supported brackets to the base plate through distributed contact points, enhancing the load-bearing capacity of the assembly.

In some embodiments, the elongated arch structure includes at least one securing hole configured to receive a securing screw for retaining an L-shaped bracket within the vertical slot. The securing hole provides positive retention of inserted brackets and prevents vertical movement during operational loading, ensuring stable support for curtain rods or shelving systems.

In some embodiments, the rear surface comprises a flat surface configured for flush contact with the wall. The flat rear surface provides maximum contact area with the mounting surface and ensures even load distribution across the base plate structure, preventing stress concentrations that could lead to mounting failure.

The presently disclosed subject matter is directed to a mounting bracket system comprising a mounting bracket wherein the first, second, third, and fourth angled holes are defined by angled cylinders extending outwardly from the front surface, and a snap-on facial cover configured to attach to the front surface of the base plate and conceal components of the mounting bracket while maintaining access to the vertical slot. The snap-on facial cover provides aesthetic enhancement by presenting a uniform exterior surface that integrates with interior design elements while maintaining the functional capabilities of the mounting bracket assembly through aligned openings that preserve access to the vertical slot.

In some embodiments, the snap-on facial cover comprises an exterior wall and a perimeter wall extending rearward from the exterior wall. The perimeter wall provides the structural interface for attaching the cover to the mounting bracket and creates an enclosure that conceals the underlying mounting components while maintaining proper dimensional relationships with the base plate structure.

In some embodiments, the snap-on facial cover includes an upper entrance and a lower entrance aligned with the vertical slot. The aligned entrances maintain functional access to the vertical slot for L-shaped bracket insertion and positioning while the cover remains installed, preserving the concealment function without compromising operational capability.

In some embodiments, the snap-on facial cover includes magnetic attachment means for securing the cover to the base plate. The magnetic attachment system provides convenient installation and removal without requiring mechanical fasteners or complex alignment procedures, while maintaining secure positioning during normal use conditions.

In some embodiments, the mounting bracket system comprises a plurality of mounting brackets spaced apart from each other and configured to collectively support a curtain rod. The multiple-bracket configuration distributes mounting loads across multiple attachment points and provides redundant support for extended spans, enhancing the overall stability and load-bearing capacity of curtain rod installations.

In some embodiments, the mounting bracket system further comprises wall fastening screws extending through the angled holes, wherein screws extending through the first and second angled holes are oriented at downward angles and screws extending through the third and fourth angled holes are oriented at upward angles to create opposing force vectors. The opposing angular orientation generates converging force vectors that draw the base plate firmly against the wall surface and distribute mounting loads across multiple attachment points, providing enhanced holding capacity compared to conventional perpendicular fastening approaches.

The presently disclosed subject matter is directed to a mounting kit comprising a mounting bracket system wherein the angled cylinders extend at angles between 15 degrees and 45 degrees from perpendicular to the rear surface, and wherein the snap-on facial cover includes attachment means for securing to the base plate, and a template system comprising a length-adjustable member, connection tabs configured to engage vertical slots of multiple mounting brackets, and a level indicator for alignment during installation. The template system enables accurate positioning of multiple mounting brackets at predetermined spacing intervals while providing leveling reference to ensure proper horizontal alignment, reducing installation time and improving installation accuracy compared to conventional measuring and marking methods.

In some embodiments, the template system includes a first connection tab positioned at a first end of the length-adjustable member and a second connection tab positioned at a second end of the length-adjustable member. The connection tabs establish mechanical connections with the vertical slots of mounting brackets, maintaining predetermined spacing relationships during installation and preventing displacement that could affect final positioning accuracy.

In some embodiments, the level indicator comprises a bubble level integrated into the length-adjustable member. The bubble level provides visual indication of proper horizontal alignment and enables real-time adjustment of mounting bracket positions during installation, ensuring that supported curtain rods or shelves maintain proper horizontal orientation across the installation span.

In some embodiments, the template system further comprises a window trim block configured to contact window trim for positioning the mounting brackets relative to the window trim. The window trim block provides consistent reference positioning that accounts for variations in window trim installation and ensures uniform spacing across multiple mounting bracket installations, maintaining proper clearance for curtain operation while preserving aesthetic proportions.

In some embodiments, the template system comprises a first length-adjustable member and a second length-adjustable member extending perpendicular to the first length-adjustable member. The perpendicular configuration creates an L-shaped template geometry that corresponds to typical window trim installations, allowing the template to align with both horizontal and vertical trim elements simultaneously for comprehensive positioning reference.

In some embodiments, the connection tabs are configured to insert into the vertical slots of the mounting brackets to establish mechanical connections during installation. The mechanical connections temporarily secure the mounting brackets in proper spatial relationships while fasteners are installed, preventing displacement and ensuring accurate final positioning of the mounting bracket assembly.

In some embodiments, the template system is configured to maintain a predetermined spacing between multiple mounting brackets during installation. The predetermined spacing capability accommodates standard shelf and curtain rod configurations while providing adjustability for custom applications, ensuring proper support distribution and operational clearances for the supported hardware.

### BRIEF DESCRIPTION OF FIGURES

Non-limiting and non-exhaustive examples are described with reference to the following figures.

FIG. 1 illustrates a front perspective view of a mounting bracket, according to aspects of the present disclosure.

FIG. 2 illustrates a front elevation view of the mounting bracket of FIG. 1, according to aspects of the present disclosure.

FIG. 3 illustrates a side perspective view of the mounting bracket of FIG. 1, according to aspects of the present disclosure.

FIG. 4 illustrates a side perspective view of the mounting bracket of FIG. 1, according to aspects of the present disclosure.

FIG. 5 illustrates a rear perspective view of the mounting bracket of FIG. 1, according to aspects of the present disclosure.

FIG. 6 illustrates a rear elevation view of the mounting bracket of FIG. 1, according to aspects of the present disclosure.

FIG. 7 illustrates a rear perspective view of the mounting bracket of FIG. 1, according to aspects of the present disclosure.

FIG. 8 illustrates a top plan view of the mounting bracket of FIG. 1, according to aspects of the present disclosure.

FIG. 9 illustrates a bottom plan view of the mounting bracket of FIG. 1, according to aspects of the present disclosure.

FIG. 10 illustrates a front perspective view of an alternative mounting bracket, according to aspects of the present disclosure.

FIG. 11 illustrates a front elevation view of the mounting bracket of FIG. 10, according to aspects of the present disclosure.

FIG. 12 illustrates a side elevation view of the mounting bracket of FIG. 10, according to aspects of the present disclosure.

FIG. 13 illustrates a side elevation view of the mounting bracket of FIG. 10, according to aspects of the present disclosure.

FIG. 14 illustrates a rear elevation view of the mounting bracket of FIG. 10, according to aspects of the present disclosure.

FIG. 15 illustrates a rear perspective view of the mounting bracket of FIG. 10, according to aspects of the present disclosure.

FIG. 16 illustrates a front perspective view of the mounting bracket of FIG. 10, according to aspects of the present disclosure.

FIG. 17 illustrates a top perspective view of the mounting bracket of FIG. 10, according to aspects of the present disclosure.

FIG. 18 illustrates a rear perspective view of a snap-on facial cover, according to aspects of the present disclosure.

FIG. 19 illustrates a front perspective view of the snap-on facial cover of FIG. 18, according to aspects of the present disclosure.

FIG. 20 illustrates a rear perspective view of the snap-on facial cover of FIG. 18, according to aspects of the present disclosure.

FIG. 21 illustrates a front perspective view of the snap-on facial cover of FIG. 18, according to aspects of the present disclosure.

FIG. 22 illustrates a front elevation view of the mounting bracket of FIG. 1 attached to a wall, according to aspects of the present disclosure.

FIG. 23 illustrates a rear elevation view of the snap-on facial cover of FIG. 18, according to aspects of the present disclosure.

FIG. 24 illustrates the mounting bracket of FIG. 1 supporting a curtain rod support, according to aspects of the present disclosure.

FIG. 25 illustrates the mounting bracket of FIG. 1 with the snap-on facial cover supporting a curtain rod support, according to aspects of the present disclosure.

FIG. 26 illustrates a top front perspective view of a template for mounting shelves, according to aspects of the present disclosure.

FIG. 27 illustrates a rear front perspective view of the template of FIG. 26, according to aspects of the present disclosure.

FIG. 28 illustrates a rear elevation view of the template of FIG. 26, according to aspects of the present disclosure.

FIG. 29 illustrates a front elevation view of the template of FIG. 26, according to aspects of the present disclosure.

FIG. 30 illustrates a front elevation view of the template of FIG. 26 with two mounting brackets, according to aspects of the present disclosure.

FIG. 31 illustrates a perspective view of a template for mounting window curtain rods, according to aspects of the present disclosure.

FIG. 32 illustrates a side elevation view of the template of FIG. 31, according to aspects of the present disclosure.

FIG. 33 illustrates a front perspective view of the template of FIG. 31, according to aspects of the present disclosure.

Common reference numerals are used throughout the figures to indicate similar features.

### DETAILED DESCRIPTION

The mounting bracket system provides an enhanced mounting solution for supporting curtain rods and shelving applications through a combination of structural design features that address limitations of conventional mounting approaches. The system comprises a base plate configured with multiple angled fastening points and a vertical slot structure that accommodates various bracket configurations.

The base plate defines a flat rear surface for flush mounting to a wall or surface and includes upper extending tabs positioned at the upper portion of the mounting bracket. These upper extending tabs define angled holes configured to receive fasteners at a downward angle into the mounting surface. A bottom portion of the base plate similarly defines angled holes configured to receive fasteners at an upward angle. This angled fastening configuration creates a pinching action between the upper and lower fastening points, providing enhanced stability compared to conventional perpendicular fastening methods.

A vertical slot structure is integrated into the front surface of the base plate and is configured to receive and support L-shaped brackets commonly used with curtain rod supports and shelving systems. The vertical slot provides both upper and lower access points, allowing for insertion and positioning of bracket components while maintaining secure retention during use.

The mounting bracket system addresses the problem of inadequate wall attachment by providing a larger footprint and multiple attachment points distributed across the base plate structure. This configuration distributes mounting loads across a greater surface area and through multiple fastening points, reducing the likelihood of the mounting bracket becoming unfastened from the wall over time due to repeated loading or environmental factors.

The system is configured for use in multiple-bracket installations where two or more mounting brackets work together to support curtain rod supports or shelving brackets. In such installations, the mounting brackets are positioned at predetermined spacing to accommodate the span of the supported structure, with each mounting bracket providing independent attachment to the mounting surface while collectively supporting the horizontal load distribution of the curtain rod or shelf system.

The vertical slot configuration accommodates various bracket geometries, including L-shaped brackets commonly used in curtain rod and shelving applications. The slot dimensions and access points allow for straightforward insertion and removal of supported brackets while maintaining secure positioning during normal use conditions.

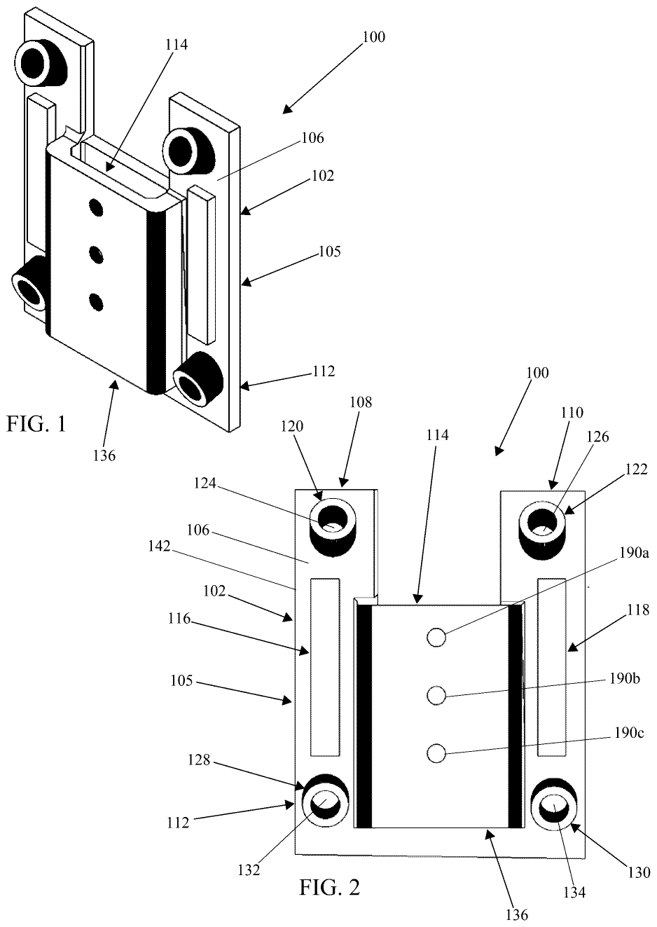

FIG. 1 and FIG. 2 illustrate a mounting bracket 100 according to various embodiments. The mounting bracket 100 comprises a base plate 102 that forms the primary structural component of the assembly. The base plate 102 defines a central body portion 105 and includes a front surface 106 configured for receiving and attaching to an end of a curtain rod support.

The mounting bracket 100 includes a first upper extending tab 108 and a second upper extending tab 110 positioned at the upper portion of the base plate 102. These upper extending tabs 108, 110 extend outward from the central body portion 105 and provide mounting points for wall attachment. A bottom portion 112 is positioned at the lower section of the base plate 102 and similarly provides additional mounting points for securing the mounting bracket 100 to a wall surface.

A vertical slot 114 is formed with the base plate 102 and extends longitudinally along the front surface 106. The vertical slot 114 is configured to receive an L-shaped bracket of a curtain rod support system. An elongated arch 136 is attached to the front surface 106 and defines the boundaries of the vertical slot 114, providing structural support around the vertical slot 114 opening. The elongated arch 136 may provide one or more vertically aligned central securing holes 190 adapted to receive one or more securing screws 302 or thumb screws. In the illustrated version, a first, second, and third securing holes, 190a, 190b, and 190c are provided.

The mounting bracket 100 further includes a first reinforcement tab 116 and a second reinforcement tab 118 that are integrated with the front surface 106 of the base plate 102. These reinforcement tabs 116, 118 are positioned on each side of the elongated arch 136 and provide additional structural rigidity to the mounting bracket 100 assembly.

The first upper extending tab 108 defines a first angled cylinder 120 that extends outwardly and upwardly from the front surface 106. The first angled cylinder 120 defines a first angled hole 124 configured to receive a wall fastening screw 300 at a downward angle into the wall surface. Similarly, the second upper extending tab 110 defines a second angled cylinder 122 that extends outwardly and upwardly from the front surface 106. The second angled cylinder 122 defines a second angled hole 126 configured to receive a wall fastening screw 300 at a downward angle.

The bottom portion 112 defines a third angled cylinder 128 and a fourth angled cylinder 130 that extend outwardly and downwardly from the front surface 106. The third angled cylinder 128 defines a third angled hole 132, and the fourth angled cylinder 130 defines a fourth angled hole 134. These angled cylinders 128, 130 are configured to receive wall fastening screw 300 at an upward angle into the wall surface.

The angled configuration of the cylinders 120, 122, 128, 130 creates a pinching action between the upper and lower fastening points when the wall fastening screw 300 are installed. The screws extending through the first angled hole 124 and second angled hole 126 are oriented at a downward angle, while the screws extending through the third angled hole 132 and fourth angled hole 134 are oriented at an upward angle. This opposing angular orientation generates compressive forces that draw the base plate 102 firmly against the wall surface and distribute mounting loads across multiple attachment points.

The base plate 102 includes a base plate perimeter 142 that defines the outer boundary of the mounting bracket 100 structure. The base plate perimeter 142 encompasses the central body portion 105, the upper extending tabs 108, 110, and the bottom portion 112, providing a unified mounting platform with a distributed footprint for wall attachment.

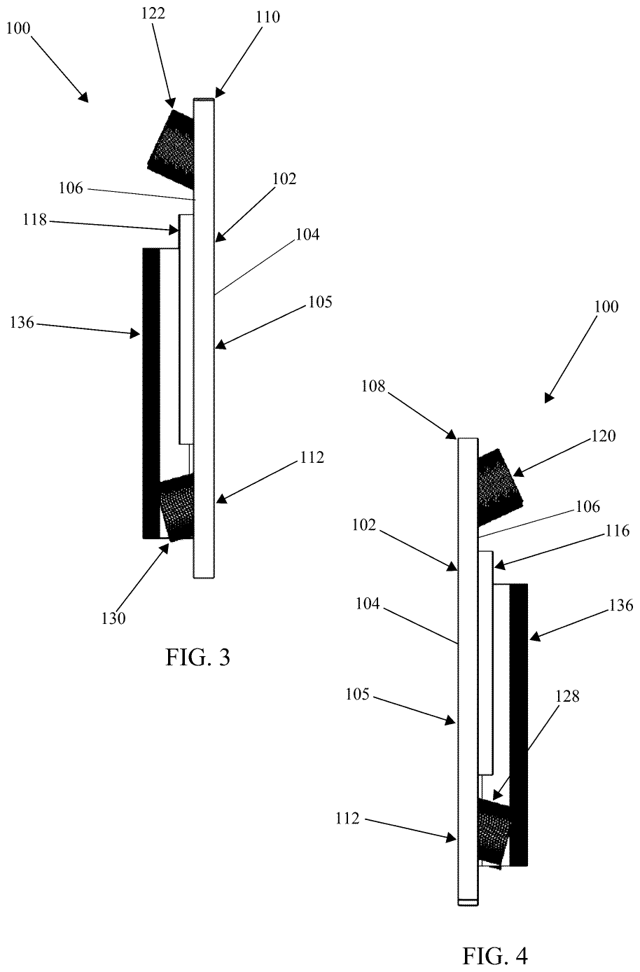

FIG. 3 and FIG. 4 illustrate side perspective views of the mounting bracket 100, showing the side configuration of the base plate 102 components. The base plate 102 defines a rear flat surface 104 that provides a flat mounting interface configured for flush contact with a wall or mounting surface. The rear flat surface 104 extends across the entire base plate perimeter 142, encompassing the central body portion 105, the first upper extending tab 108, the second upper extending tab 110, and the bottom portion 112.

The angled cylinders 120, 122, 128, 130 extend outwardly from the front surface 106 at specific angular orientations relative to the rear flat surface 104. The first angled cylinder 120 and the second angled cylinder 122 are oriented at an angle between 15 degrees and 45 degrees relative to perpendicular to the wall surface, extending outwardly and upwardly from their respective upper extending tabs 108, 110. The third angled cylinder 128 and the fourth angled cylinder 130 are similarly oriented at an angle between 15 degrees and 45 degrees relative to perpendicular to the wall surface, extending outwardly and downwardly from the bottom portion 112.

The elongated arch 136 is integrated into the front surface 106 of the base plate 102 and defines the structural boundaries of the vertical slot 114. The elongated arch 136 provides an upper entrance and a lower entrance that allow access to the vertical slot 114 from both the top and bottom directions. The vertical slot 114 extends vertically through a central portion of the base plate 102, positioned between the upper extending tabs 108, 110 and the bottom portion 112. The vertical length of the vertical slot 114 is configured to accommodate L-shaped brackets by allowing the bracket to slide downward into the upper entrance and seat within the slot structure.

The first reinforcement tab 116 and the second reinforcement tab 118 are positioned on opposite sides of the elongated arch 136 and extend vertically from the front surface 106. These reinforcement tabs 116, 118 provide structural support to the elongated arch 136 and distribute loads applied to the vertical slot 114 across the base plate 102 structure. The reinforcement tabs 116, 118 are integrally formed with the front surface 106 and extend parallel to the vertical orientation of the elongated arch 136.

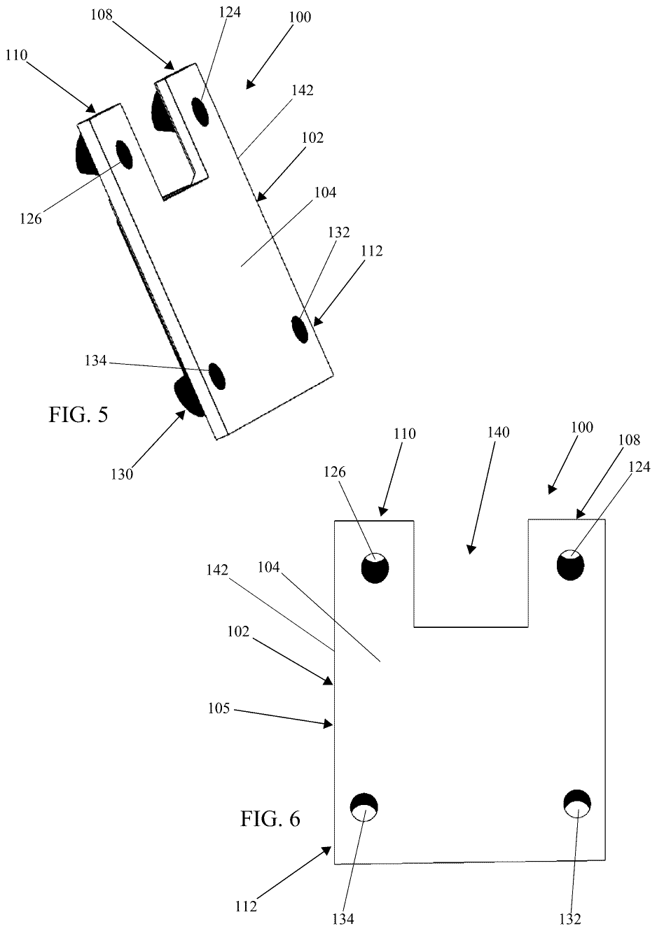

FIG. 5 and FIG. 6 illustrate rear views of the mounting bracket 100, showing the configuration of the rear flat surface 104 and the positioning of the angled holes 124, 126, 132, 134 as they extend through the base plate 102 structure. The rear flat surface 104 provides a continuous mounting interface that spans the base plate perimeter 142. A rectangular open space 140 is defined within the rear flat surface 104, corresponding to the position of the vertical slot 114 on the front surface 106.

The first angled hole 124 and the second angled hole 126 extend through the first upper extending tab 108 and the second upper extending tab 110 respectively, with the holes oriented to receive wall fastening screw 300 at the predetermined downward angle. The third angled hole 132 and the fourth angled hole 134 extend through the bottom portion 112, with the holes oriented to receive wall fastening screw 300 at the predetermined upward angle. The angled fastening holes 124, 126, 132, 134 are positioned on opposite sides of the vertical slot 114, with the first angled hole 124 and third angled hole 132 positioned on one side, and the second angled hole 126 and fourth angled hole 134 positioned on the opposite side.

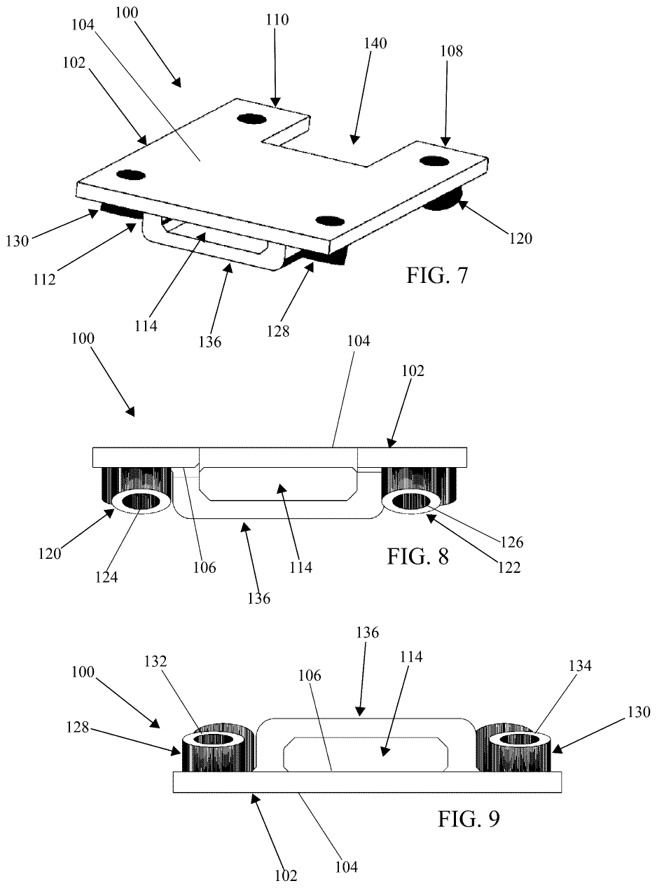

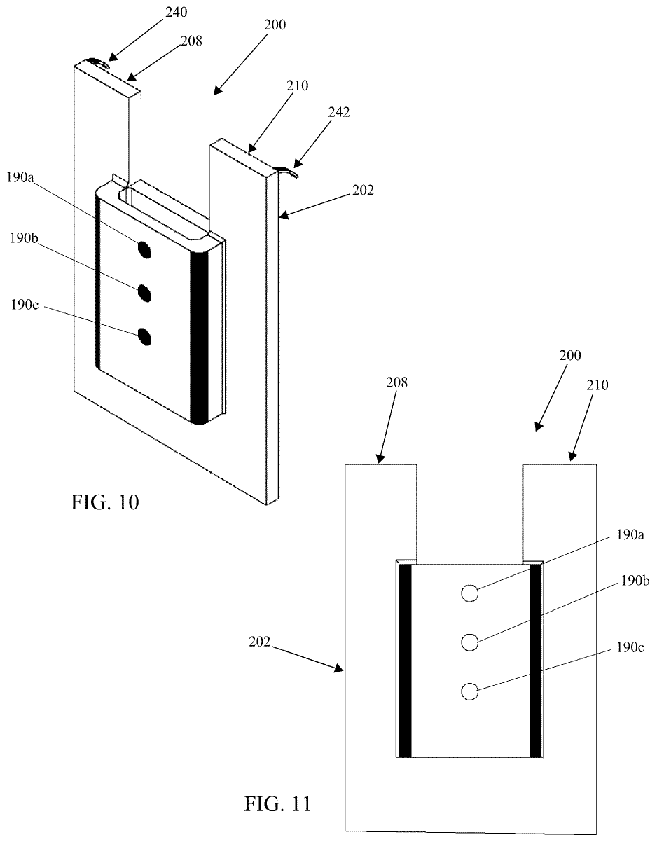

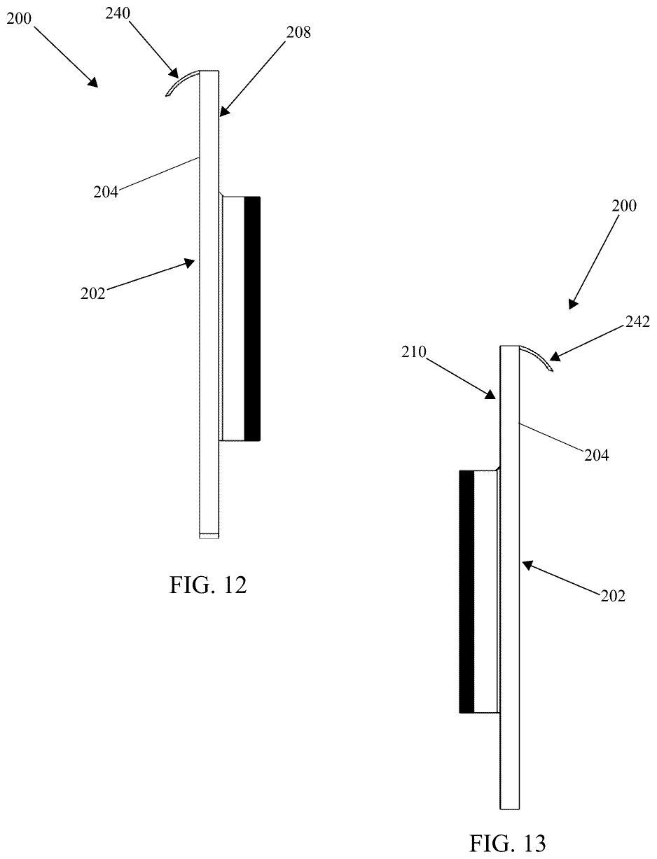

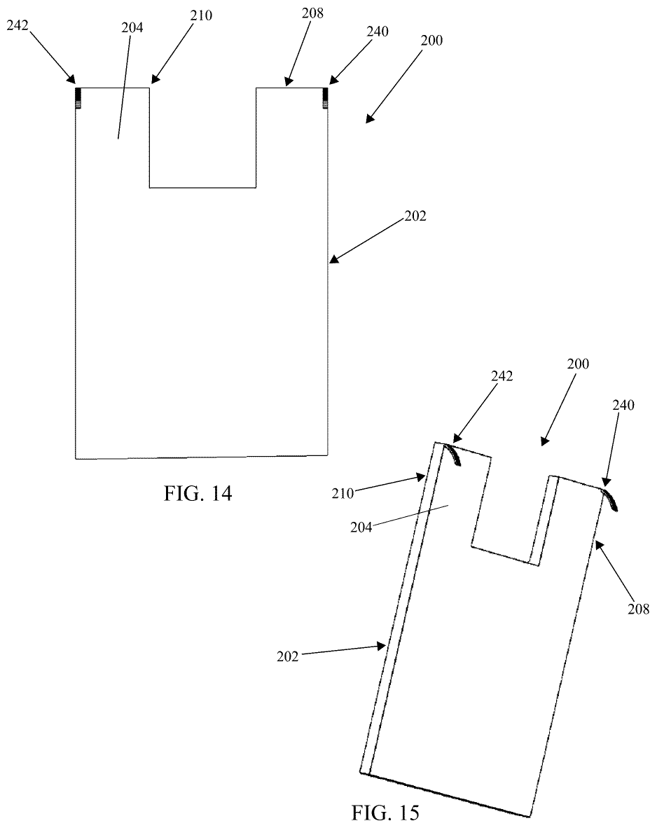

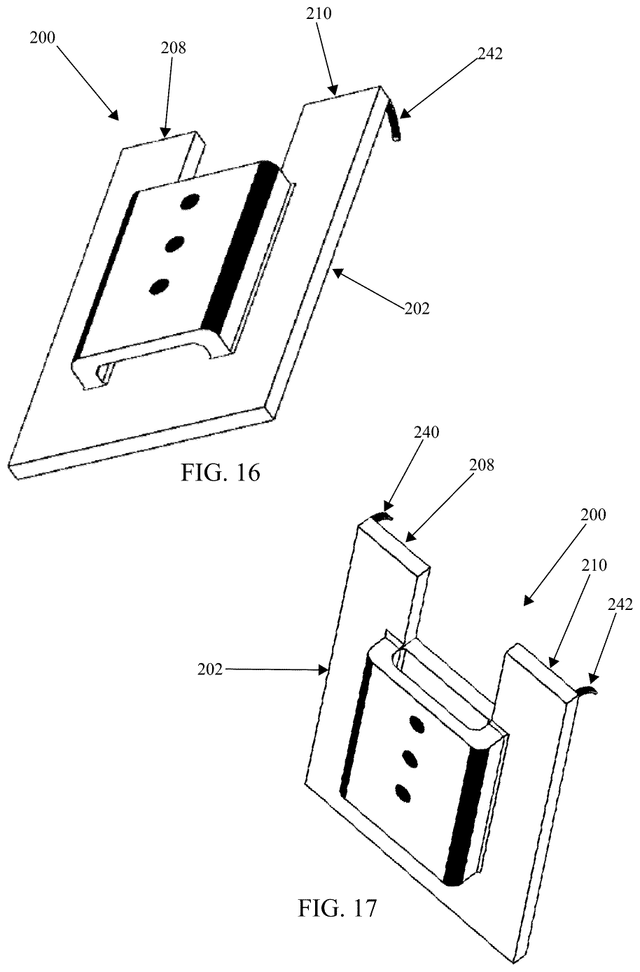

FIG. 7, FIG. 8, and FIG. 9 illustrate additional views of the mounting bracket 100, showing the spatial relationships between the various components and the integration of the angled cylinders 120, 122, 128, 130 with the base plate 102 structure. The rectangular open space 140 extends through the base plate 102 and corresponds to the vertical slot 114 configuration, providing clearance for the insertion and positioning of L-shaped brackets within the mounting bracket 100 assembly.

The angled cylinders 120, 122, 128, 130 are integrally formed with the base plate 102 and extend outwardly from the front surface 106 to provide reinforced mounting points for the wall fastening screw 300. The cylindrical structure of each angled cylinder 120, 122, 128, 130 provides a bearing surface for the wall fastening screw 300 and distributes fastening loads across the base plate 102 material. The angled orientation of the cylinders 120, 122, 128, 130 directs the wall fastening screw 300 into the wall surface at the predetermined angles, creating the pinching action that secures the mounting bracket 100 to the mounting surface.

The mounting bracket 100 operates through a coordinated interaction between the angled fastening system and the vertical slot structure to provide enhanced mounting stability and secure bracket retention. The angled cylinders 120, 122, 128, 130 work in conjunction with their respective angled holes 124, 126, 132, 134 to create a mechanical advantage when the wall fastening screws 300 are installed.

When the wall fastening screws 300 are inserted through the first angled hole 124 and the second angled hole 126, the screws extend at a downward angle through the first angled cylinder 120 and the second angled cylinder 122, respectively. Simultaneously, when the wall fastening screws 300 are inserted through the third angled hole 132 and the fourth angled hole 134, the screws extend at an upward angle through the third angled cylinder 128 and the fourth angled cylinder 130, respectively. This opposing angular configuration generates converging force vectors that draw the base plate 102 against the mounting surface with increased holding force compared to perpendicular fastening methods.

The pinching action created by the opposing angular forces distributes mounting loads across the entire base plate perimeter 142 rather than concentrating stress at individual fastening points. The first upper extending tab 108 and the second upper extending tab 110 transfer downward-angled fastening forces to the central body portion 105, while the bottom portion 112 transfers upward-angled fastening forces to the same central structure. This load distribution reduces the likelihood of fastener pullout or base plate deformation under operational loads.

The vertical slot 114 receives L-shaped brackets through the upper entrance defined by the elongated arch 136 and the base plate 102. The vertical slot 114 has a width configured to accommodate a vertical portion of the L-shaped bracket, allowing the bracket to slide downward into the slot structure and seat securely within the elongated arch 136. The width of the vertical slot 114 provides sufficient clearance for bracket insertion while maintaining lateral stability once the bracket is positioned within the slot.

The elongated arch 136 provides structural containment for the inserted L-shaped bracket by defining the lateral boundaries of the vertical slot 114. The arch structure transfers loads applied by the supported bracket to the base plate 102 through the front surface 106, distributing these loads across the mounting bracket 100 assembly. The vertical orientation of the vertical slot 114 allows gravity to assist in maintaining the L-shaped bracket in the seated position within the slot structure.

The first reinforcement tab 116 and the second reinforcement tab 118 provide additional structural support to the elongated arch 136 and the vertical slot 114 assembly. These reinforcement tabs 116, 118 resist lateral deflection of the elongated arch 136 under load conditions and transfer applied forces to the central body portion 105 of the base plate 102. The reinforcement tabs 116, 118 extend vertically parallel to the vertical slot 114, providing structural continuity along the length of the slot opening.

The multiple attachment points created by the four angled holes 124, 126, 132, 134 distribute the mounting loads across a larger area of the mounting surface compared to conventional two-point mounting systems. Each wall fastening screw 300 contributes to the overall holding capacity of the mounting bracket 100, with the angled orientation providing resistance to both withdrawal forces and lateral displacement. The distributed attachment pattern reduces stress concentrations in the mounting surface material and provides redundancy in the event of individual fastener loosening. The vertical slot 114 is strategically positioned offset lower between the upper attachment points defined by the first angled hole 124 and second angled hole 126 and the lower attachment points defined by the third angled hole 132 and fourth angled hole 134, creating an asymmetrical configuration that optimizes load distribution while providing clearance for L-bracket insertion and positioning within the mounting bracket assembly.

The rectangular open space 140 in the rear flat surface 104 between the first upper extending tab 108 and the second upper extending tab 110 provides clearance for the vertical slot 114 structure while maintaining a continuous mounting interface around the base plate perimeter 142. This configuration allows the rear flat surface 104 to maintain full contact with the mounting surface across the attachment areas while accommodating the three-dimensional structure of the vertical slot 114 and the elongated arch 136. The rectangular open space 140 further provides clearance for insertion of the L-bracket 18 through the top opening of the vertical slot 114, allowing the vertical portion of the L-bracket 18 to pass through the rear of the mounting bracket 100 during installation and positioning within the vertical slot 114 structure.

FIG. 10 and FIG. 11 illustrate a mounting bracket 200 according to various embodiments that provides an alternative mounting approach to the mounting bracket 100 previously described. The mounting bracket 200 comprises a base plate 202 that forms the primary structural component of the assembly and shares similar dimensional characteristics with the base plate 102 of the mounting bracket 100, while incorporating a different fastening mechanism for wall attachment.

The mounting bracket 200 includes a first upper extending tab 208 and a second upper extending tab 210 positioned at the upper portion of the base plate 202. These upper extending tabs 208, 210 extend outward from the main body of the base plate 202 and provide mounting points for wall attachment through an integrated nail hook system rather than the angled screw fastening system used in the mounting bracket 100.

A first nail hook 240 extends rearward from the first upper extending tab 208, specifically from the upper and outermost corner of the first upper extending tab 208. Similarly, a second nail hook 242 extends rearward from the second upper extending tab 210, specifically from the upper and outermost corner of the second upper extending tab 210. The first nail hook 240 and the second nail hook 242 are configured to engage with a wall surface by hooking downward into the wall material, providing an alternative mounting method that does not require pre-drilled holes or threaded fasteners.

The nail hook system of the mounting bracket 200 provides a simplified installation process compared to the angled screw system of the mounting bracket 100. The first nail hook 240 and the second nail hook 242 are positioned symmetrically on opposite sides of the base plate 202, creating a balanced mounting configuration that distributes attachment loads across two discrete contact points at the upper portion of the mounting bracket 200.

The base plate 202 maintains the same general configuration as the base plate 102, including the vertical slot structure and reinforcement features that accommodate L-shaped brackets and provide structural support for curtain rod and shelving applications. The primary difference between the mounting bracket 200 and the mounting bracket 100 lies in the upper attachment mechanism, where the nail hook system replaces the angled cylinder and screw configuration while maintaining the same functional capability for supporting mounted hardware.

The mounting bracket 200 configuration addresses installation scenarios where rapid deployment is preferred or where access to drilling tools and threaded fasteners may be limited. The first nail hook 240 and the second nail hook 242 allow the mounting bracket 200 to be installed by pressing the hooks into the wall surface and allowing the hook geometry to penetrate and engage with the wall material, creating a mechanical connection without requiring additional hardware.

The nail hook engagement mechanism of the mounting bracket 200 operates through a penetration and retention system that creates secure attachment to wall surfaces through mechanical interference. The first nail hook 240 and the second nail hook 242 are configured with pointed or sharpened ends that penetrate into wall materials such as drywall, wood, or similar substrates when the mounting bracket 200 is pressed against the mounting surface.

The hooking mechanism functions by allowing the first nail hook 240 and the second nail hook 242 to penetrate the wall surface to a predetermined depth, after which the hook geometry engages with the wall material to resist withdrawal forces. The rearward extension of the nail hooks 240, 242 from the upper extending tabs 208, 210 positions the penetration points at locations that maximize the mechanical advantage of the hook engagement while distributing attachment loads across the upper portion of the base plate 202.

The mounting bracket 200 incorporates a dual attachment approach that combines the nail hook system with angled fastening holes positioned at the lower portion of the base plate 202. This dual attachment configuration provides both rapid initial positioning through the nail hook engagement and enhanced holding capacity through the angled fastening system. The angled fastening holes are oriented to direct the fasteners at angles that provide increased resistance to pull-out forces, creating a mechanical advantage that supplements the holding capacity of the nail hook system.

The combination of the nail hook system and the angled fastening holes creates a mounting configuration that addresses different phases of the installation process and different types of loading conditions. The first nail hook 240 and the second nail hook 242 provide immediate attachment that allows the mounting bracket 200 to be positioned and held in place during the installation of the angled fasteners. Once the angled fasteners are installed through the angled fastening holes, the mounting bracket 200 achieves full holding capacity through the combined action of both attachment systems.

The dual attachment approach provides advantages for different wall types and installation scenarios by accommodating varying wall material properties and installation requirements. For drywall installations, the nail hook system provides initial penetration and positioning capability, while the angled fastening holes accommodate threaded fasteners that engage with wall studs or anchoring systems for enhanced load capacity. For wood wall installations, both the nail hook system and the angled fastening system can engage directly with the wood material, providing redundant attachment points that increase overall holding capacity.

The angled orientation of the fastening holes creates converging force vectors that resist both withdrawal and lateral displacement of the mounting bracket 200. The angled fasteners work in conjunction with the nail hook system to create a distributed loading pattern that reduces stress concentrations at individual attachment points. The nail hooks 240, 242 primarily resist upward and outward forces, while the angled fasteners resist downward and inward forces, creating a balanced attachment system that accommodates various loading directions.

The mounting bracket 200 configuration accommodates installation scenarios where temporary positioning is required before final fastening, such as when marking fastener locations or when coordinating the installation of multiple mounting brackets. The nail hook system allows the mounting bracket 200 to be temporarily secured to the wall surface while maintaining the ability to make fine adjustments to position before installing the angled fasteners through the angled fastening holes.

The vertical slot structure of the mounting bracket 200 functions identically to the mounting bracket 100 configuration, providing accommodation for L-shaped brackets used in various applications. An L-shaped bracket configured to support a curtain rod engages with the vertical slot by inserting the vertical portion of the L-shaped bracket into the slot opening, allowing the horizontal portion of the L-shaped bracket to extend outward from the mounting bracket 200 to provide a support point for the curtain rod. The vertical slot dimensions accommodate standard curtain rod bracket configurations while providing secure retention through the slot geometry.

An L-shaped bracket configured to support a shelf similarly engages with the vertical slot through insertion of the vertical bracket portion, with the horizontal portion extending outward to provide a shelf support surface. The mounting bracket 200 accommodates various shelf bracket configurations through the adjustable positioning capability of the vertical slot, allowing the L-shaped bracket to be positioned at different heights within the slot structure to accommodate different shelf mounting requirements.

The dual attachment system of the mounting bracket 200 provides enhanced holding capacity for both curtain rod and shelf applications by distributing mounting loads across multiple attachment points and multiple attachment mechanisms. The nail hook system provides resistance to upward forces that may be applied during curtain operation or shelf loading, while the angled fastening system provides resistance to downward and outward forces that result from the weight of supported items and operational loading conditions.

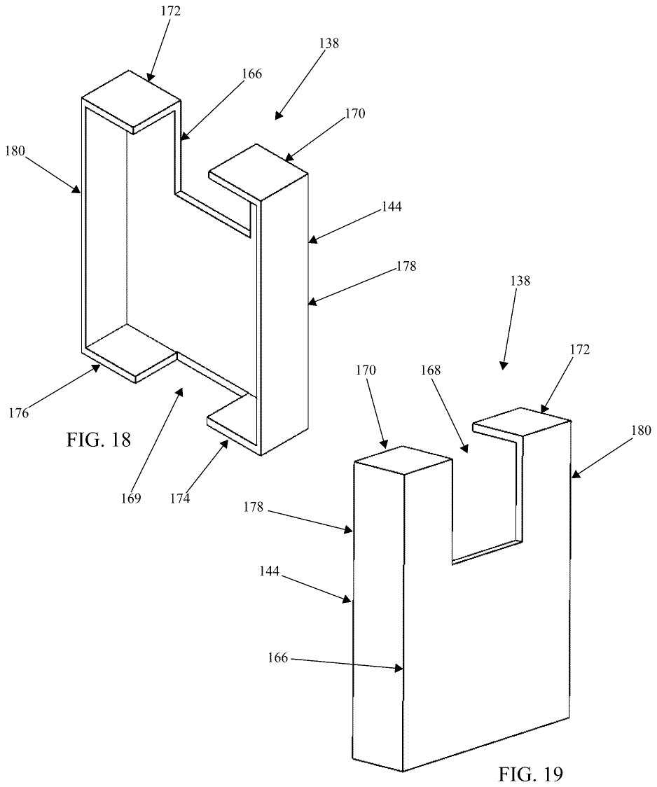

FIG. 18 and FIG. 19 illustrate a mounting bracket system comprising the mounting bracket 100 or the mounting bracket 200 and a snap-on facial cover 138 configured for attachment to the mounting bracket 100 or the mounting bracket 200. The snap-on facial cover 138 provides an overall profile that mirrors the front surface 106 profile of the base plate 102 and is configured to conceal the mounting components while maintaining functional L-bracket access to the vertical slot 114.

The snap-on facial cover 138 comprises an exterior wall 166 that forms the visible surface of the cover assembly when installed on the mounting bracket 100 or the mounting bracket 200. The exterior wall 166 defines the outer boundary of the snap-on facial cover 138 and provides a finished appearance that conceals the underlying structural components of the base plate 102, including the elongated arch 136, the angled cylinders 120, 122, 128, 130, and the angled holes 124, 126, 132, 134.

A perimeter wall 144 extends rearward from the exterior wall 166, forming a generally rectangular enclosure that defines the internal volume of the snap-on facial cover 138. The perimeter wall 144 is configured to engage with the front surface 106 perimeter 142 of the base plate 102 and provides the structural interface for attaching the snap-on facial cover 138 to the mounting bracket assembly. The perimeter wall 144 extends around the entire perimeter of the exterior wall 166, creating a continuous boundary that encompasses the mounting components when the snap-on facial cover 138 is installed.

The exterior wall 166 comprises multiple sections that correspond to the geometric configuration of the base plate 102. A first side top portion 170 and a second side top portion 172 are positioned at the upper region of the exterior wall 166 and correspond to the first upper extending tab 108 and the second upper extending tab 110, respectively. These top portions 170, 172 are configured to align with and cover the angled cylinders 120, 122 and the angled holes 124, 126 when the snap-on facial cover 138 is installed on the mounting bracket 100.

A first side bottom portion 174 and a second side bottom portion 176 are positioned at the lower region of the exterior wall 166 and correspond to the bottom portion 112 of the base plate 102. These bottom portions 174, 176 are configured to align with and cover the angled cylinders 128, 130 and the angled holes 132, 134 when the snap-on facial cover 138 is installed. The first side bottom portion 174 and the second side bottom portion 176 provide coverage for the lower mounting components while maintaining the overall aesthetic profile of the assembly.

A first side portion 178 and a second side portion 180 extend vertically along the lateral edges of the exterior wall 166, connecting the top portions 170, 172 with the bottom portions 174, 176. The first side portion 178 and the second side portion 180 correspond to the lateral boundaries of the base plate 102 and provide continuous coverage along the sides of the mounting bracket assembly. These side portions 178, 180 are positioned to align with the first reinforcement tab 116 and the second reinforcement tab 118 when the snap-on facial cover 138 is installed.

The snap-on facial cover 138 includes a vertical opening that maintains access to the vertical slot 114 of the base plate 102 when the cover is installed. An upper entrance 168 is defined at the upper portion of the snap-on facial cover 138, providing an opening that aligns with the upper access point of the vertical slot 114. The upper entrance 168 allows L-shaped brackets to be inserted into the vertical slot 114 from above while the snap-on facial cover 138 remains in position on the mounting bracket assembly.

A lower entrance 169 is defined at the lower portion of the snap-on facial cover 138, providing an opening that aligns with the lower access point of the vertical slot 114. The lower entrance 169 provides clearance for the lower portion of inserted L-shaped brackets and allows for bracket positioning adjustments while maintaining the concealment function of the snap-on facial cover 138. The upper entrance 168 and the lower entrance 169 are aligned with each other and with the vertical slot 114 to provide continuous access through the cover assembly.

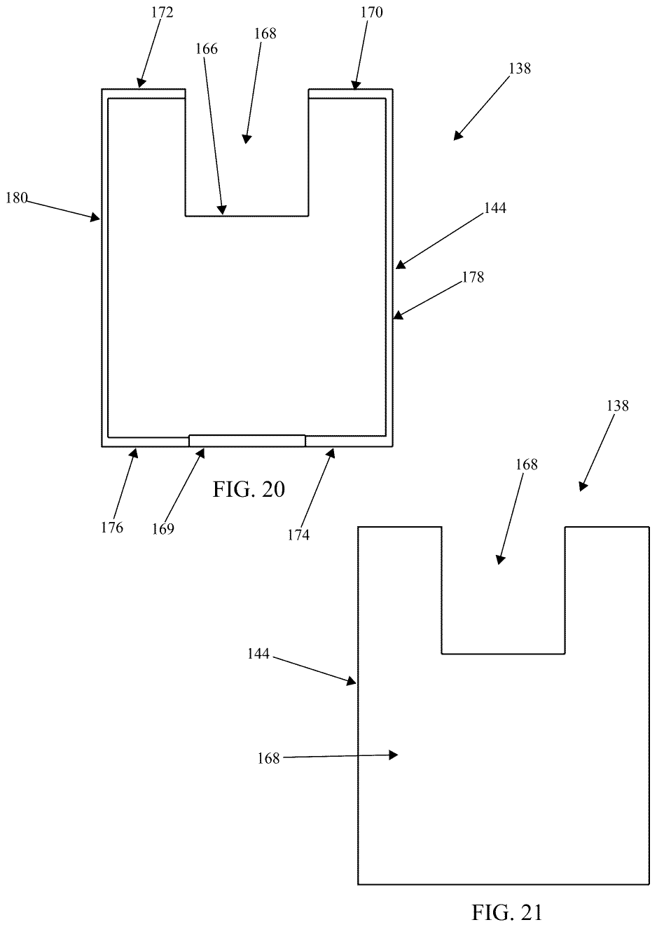

FIG. 20 and FIG. 21 illustrate rear and front elevation views of the snap-on facial cover 138, showing the configuration of the cover components and the spatial relationships between the exterior wall 166 and the perimeter wall 144. The perimeter wall 144 extends rearward from the exterior wall 166 at a depth configured to accommodate the three-dimensional structure of the mounting bracket components, including the angled cylinders 120, 122, 128, 130 and the elongated arch 136.

The snap-on facial cover 138 is configured to attach to the front surface 106 of the base plate 102 through a friction fit engagement between the perimeter wall 144 and the mounting bracket components. The perimeter wall 144 is dimensioned to engage with the outer boundaries or base plate perimeter 142 of the base plate 102, creating a secure attachment that maintains the position of the snap-on facial cover 138 during normal use conditions while allowing for removal when access to the underlying components is required.

The profile of the snap-on facial cover 138 mirrors the configuration of the base plate 102 by incorporating corresponding geometric features that align with the first upper extending tab 108, the second upper extending tab 110, the bottom portion 112, and the central body portion 105. The first side top portion 170 and the second side top portion 172 extend outward from the central region of the exterior wall 166 in a pattern that corresponds to the outward extension of the upper extending tabs 108, 110 from the central body portion 105.

The first side bottom portion 174 and the second side bottom portion 176 similarly extend outward from the central region of the exterior wall 166 in a pattern that corresponds to the configuration of the bottom portion 112. This mirroring configuration allows the snap-on facial cover 138 to provide complete coverage of the mounting bracket components while maintaining the overall dimensional profile of the assembly.

The concealment function of the snap-on facial cover 138 provides aesthetic enhancement to the mounting bracket installation by presenting a uniform exterior surface that eliminates the visual complexity of the underlying mounting components. The exterior wall 166 presents a smooth, continuous surface that integrates with interior design elements while maintaining the functional capabilities of the mounting bracket assembly through the upper entrance 168 and the lower entrance 169.

The snap-on facial cover 138 maintains the functional accessibility of the vertical slot 114 through the aligned openings of the upper entrance 168 and the lower entrance 169. L-shaped brackets can be inserted through the upper entrance 168, positioned within the vertical slot 114, and secured in place without requiring removal of the snap-on facial cover 138. The lower entrance 169 provides clearance for the lower portion of the L-shaped bracket and allows for visual confirmation of proper bracket seating within the vertical slot 114.

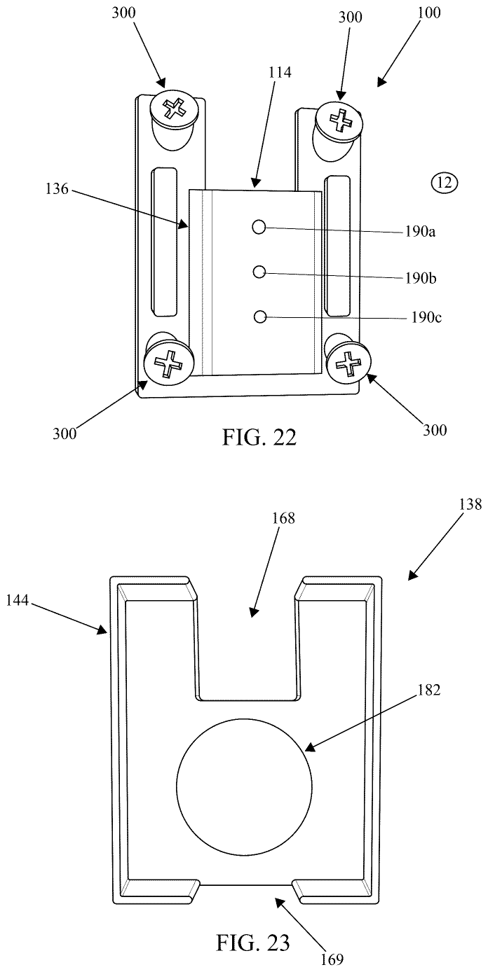

With reference to FIG. 22-FIG. 25, installation of the mounting bracket 100 will now be described. The mounting bracket 100 is secured to the wall 12 through multiple wall fastening screws 300 that extend through the angled holes 124, 126, 132, 134 at predetermined non-perpendicular angles relative to the wall surface.

Installation begins by positioning the mounting bracket 100 against the wall 12 with the rear flat surface 104 making flush contact. Pilot holes are drilled through the first angled hole 124 and second angled hole 126 at downward angles, while pilot holes through the third angled hole 132 and fourth angled hole 134 are drilled at upward angles. The wall fastening screws 300 are then inserted through the angled fastening holes into the pilot holes, with the angled cylinders 120, 122, 128, 130 guiding the screws at their respective angles. This creates converging force vectors that draw the base plate 102 firmly against the wall surface while distributing mounting loads across multiple attachment points.

The curtain rod support 10 engages with the mounting bracket 100 through the vertical slot 114 structure. The L-bracket 18 comprises a vertical portion that inserts into the vertical slot 114 and a horizontal portion extending outward to provide a support point for the curtain rod 16. The curtain rod support end 14 extends from the horizontal portion and receives the curtain rod 16 in horizontal orientation.

The vertical portion of the L-bracket 18 is inserted through the upper entrance defined by the elongated arch 136 and slides downward into the vertical slot 114. The elongated arch 136 includes vertically aligned central securing holes 190a, 190b, and 190c configured to receive horizontal securing screws 302. These securing screws 302 are steel flathead knurled thumb screws providing manual adjustment capability without additional tools. The knurled surface allows hand tightening and loosening, with the thumb screw extending through a selected central securing hole 190 to engage the vertical portion of the L-bracket 18, securing it in position and preventing vertical movement during operational loading.

As shown in FIG. 23, the snap-on facial cover 138 may be secured to the mounting bracket 100 through a magnetic attachment system utilizing magnets 182 positioned within the perimeter wall 144 structure. The magnets 182 engage with corresponding magnetic elements or ferromagnetic materials integrated into the base plate 102, creating a secure magnetic connection. This system provides convenient installation and removal without requiring mechanical fasteners or complex alignment procedures, while allowing straightforward removal when access to underlying components is required.

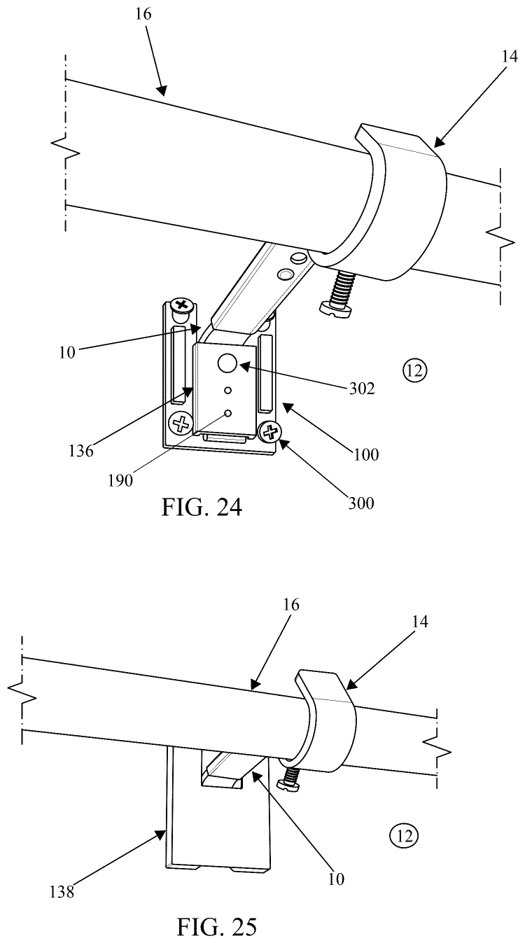

FIG. 24 and FIG. 25 illustrate the mounting bracket 100 supporting the curtain rod support 10 in both exposed and concealed configurations. FIG. 24 shows the exposed configuration where structural components are visible, including the elongated arch 136, angled cylinders 120, 122, 128, 130, and wall fastening screws 300. FIG. 25 shows the same configuration with the snap-on facial cover 138 installed, concealing structural components while maintaining functional access to the vertical slot 114 through the upper entrance 168 and lower entrance 169.

The snap-on facial cover 138 provides aesthetic enhancement by presenting a uniform exterior wall 166 surface that integrates with interior design elements. The perimeter wall 144 engages with the front surface 106 of the base plate 102, maintaining cover position during normal use while the curtain rod support end 14 and curtain rod 16 extend outward to provide the same functional support capability with improved visual appearance.

The mounting bracket system accommodates both single-bracket and multiple-bracket configurations depending on span requirements. For curtain rod applications, two or more mounting brackets are typically installed at predetermined spacing to support the curtain rod 16 across the desired span, with each mounting bracket 100 providing independent wall attachment while collectively supporting distributed loading. The vertical slot 114 accommodates various L-bracket geometries and sizes, allowing the system to support different curtain rod support 10 configurations and curtain rod 16 diameters, with adjustable positioning capability enabling fine-tuning of curtain rod support end 14 height and orientation for proper alignment across multiple installations.

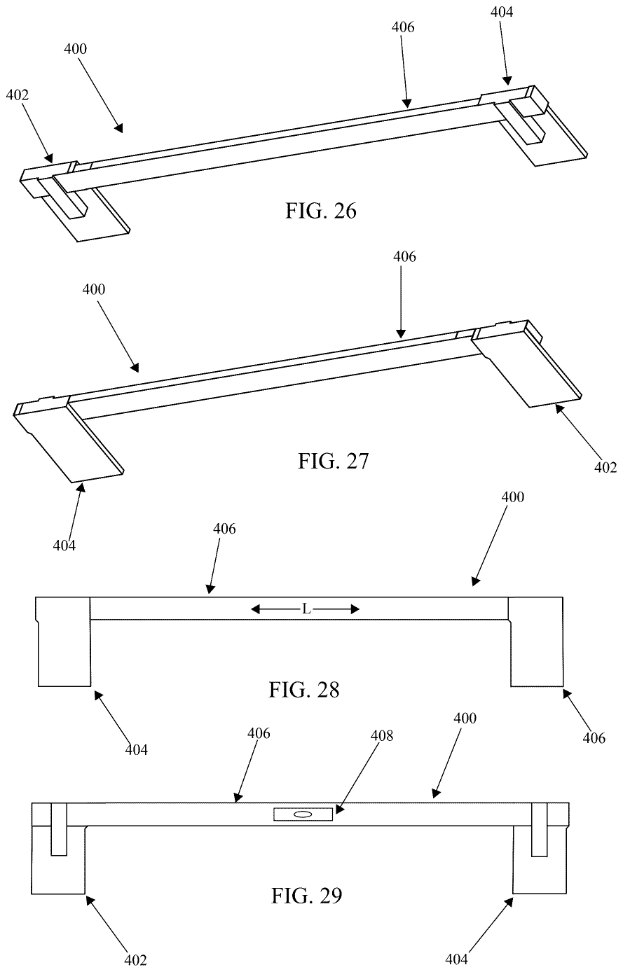

FIG. 26, FIG. 27, FIG. 28, and FIG. 29 illustrate a template for mounting shelves 400 configured to assist in positioning and installation of multiple mounting brackets at predetermined spacing intervals for shelf installation applications. The template for mounting shelves 400 provides a spacing and alignment tool that enables accurate positioning of multiple mounting brackets 100 or mounting brackets 200 at consistent distances, particularly for mounting shelves with L-bracket configurations.

The template for mounting shelves 400 comprises a first side connection tab 402 positioned at one end of the assembly and configured to engage with the vertical slot 114 of a first mounting bracket. The first side connection tab 402 includes a vertical projection that corresponds to the dimensions of the vertical slot 114, allowing the first side connection tab 402 to insert into the vertical slot 114 and establish a mechanical connection with the mounting bracket assembly. The first side connection tab 402 provides a reference point for positioning the template for mounting shelves 400 relative to the first mounting bracket during installation.

A second side connection tab 404 is positioned at the opposite end of the template for mounting shelves 400 and is configured to engage with the vertical slot 114 of a second mounting bracket. The second side connection tab 404 includes a vertical projection that corresponds to the dimensions of the vertical slot 114, allowing the second side connection tab 404 to insert into the vertical slot 114 of the second mounting bracket. The second side connection tab 404 establishes the spacing relationship between the first mounting bracket and the second mounting bracket by defining the distance between the two connection points.

A length-adjustable member 406 extends between the first side connection tab 402 and the second side connection tab 404, providing the structural connection that maintains the predetermined spacing between the mounting brackets during installation. The length-adjustable member 406 is configured to adjust lengthwise to accommodate different spacing requirements for various shelf configurations and installation applications. The adjustable capability of the length-adjustable member 406 allows the template for mounting shelves 400 to accommodate different shelf lengths and mounting bracket spacing requirements.

The length-adjustable member 406 includes adjustment mechanisms that allow the overall length of the template for mounting shelves 400 to be modified while maintaining structural rigidity between the first side connection tab 402 and the second side connection tab 404. The adjustment mechanisms provide incremental length changes that correspond to standard shelf spacing intervals, allowing the template for mounting shelves 400 to accommodate common shelf dimensions and mounting requirements.

A bubble level 408 is integrated into the template for mounting shelves 400 and is positioned along the length-adjustable member 406 to provide leveling reference during mounting bracket installation. The bubble level 408 includes a transparent vial containing a bubble that indicates horizontal alignment when the template for mounting shelves 400 is positioned against the wall 12. The bubble level 408 enables accurate horizontal alignment of multiple mounting brackets, ensuring that supported shelves will be level when installed.

The bubble level 408 provides visual indication of proper horizontal alignment by centering the bubble within the vial when the template for mounting shelves 400 is positioned correctly. The bubble level 408 allows for real-time adjustment of mounting bracket positions during installation, enabling the installer to achieve precise horizontal alignment before securing the mounting brackets to the wall 12 with the wall fastening screws 300.

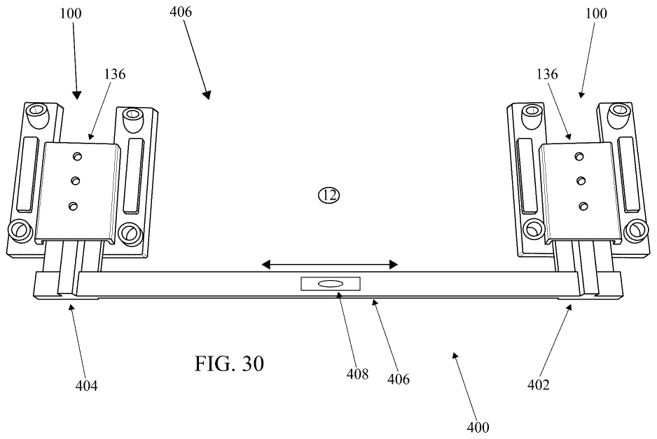

FIG. 30 illustrates the template for mounting shelves 400 in an installed configuration on the wall 12 with two mounting brackets 100, demonstrating the practical application of the template system for positioning multiple mounting brackets at consistent spacing. The template for mounting shelves 400 spans the distance between the two mounting brackets 100, with the first side connection tab 402 inserted into the vertical slot 114 of the first mounting bracket 100 and the second side connection tab 404 inserted into the vertical slot 114 of the second mounting bracket 100.

The length-adjustable member 406 maintains the predetermined spacing between the two mounting brackets 100 while the bubble level 408 provides horizontal alignment reference during the installation process. The template for mounting shelves 400 functions as a positioning guide that holds the mounting brackets 100 in the correct spatial relationship while the wall fastening screws 300 are installed through the angled holes of each mounting bracket 100.

The installation process using the template for mounting shelves 400 begins by positioning the first mounting bracket 100 at the desired location on the wall 12 and inserting the first side connection tab 402 into the vertical slot 114 of the first mounting bracket 100. The length-adjustable member 406 is adjusted to the required spacing distance for the particular shelf application, and the second mounting bracket 100 is positioned at the location indicated by the second side connection tab 404.

The second side connection tab 404 is inserted into the vertical slot 114 of the second mounting bracket 100, establishing the mechanical connection between the template for mounting shelves 400 and both mounting brackets 100. The bubble level 408 is observed to ensure horizontal alignment of the template for mounting shelves 400, and adjustments are made to the mounting bracket positions as needed to achieve proper leveling.

Once the template for mounting shelves 400 indicates proper spacing and alignment through the bubble level 408, the wall fastening screws 300 are installed through the angled holes of each mounting bracket 100 to secure the mounting brackets to the wall 12. The template for mounting shelves 400 maintains the mounting bracket positions during the fastening process, preventing displacement that could affect the final spacing and alignment of the installation.

After the mounting brackets 100 are secured to the wall 12, the template for mounting shelves 400 is removed by withdrawing the first side connection tab 402 and the second side connection tab 404 from the respective vertical slots 114. The mounting brackets 100 remain positioned at the predetermined spacing and alignment established by the template for mounting shelves 400, providing properly positioned mounting points for shelf installation.

The template for mounting shelves 400 accommodates various shelf bracket configurations by providing connection tabs 402, 404 that engage with the vertical slots 114 of the mounting brackets 100 in the same manner as L-brackets used in shelf applications. The connection tabs 402, 404 temporarily occupy the vertical slots 114 during installation, ensuring that the mounting brackets 100 are positioned to properly receive the actual shelf brackets once the template for mounting shelves 400 is removed.

The adjustable length capability of the length-adjustable member 406 allows the template for mounting shelves 400 to accommodate different shelf lengths and mounting requirements without requiring multiple template sizes. The length-adjustable member 406 provides a range of spacing distances that correspond to common shelf dimensions, making the template for mounting shelves 400 suitable for various residential and commercial shelf installation applications.

The bubble level 408 provides accuracy in horizontal alignment that exceeds the precision achievable through visual estimation alone, resulting in shelf installations that maintain proper horizontal orientation across the supported span. The bubble level 408 compensates for wall irregularities and installation variations that could otherwise result in sloped or uneven shelf positioning.

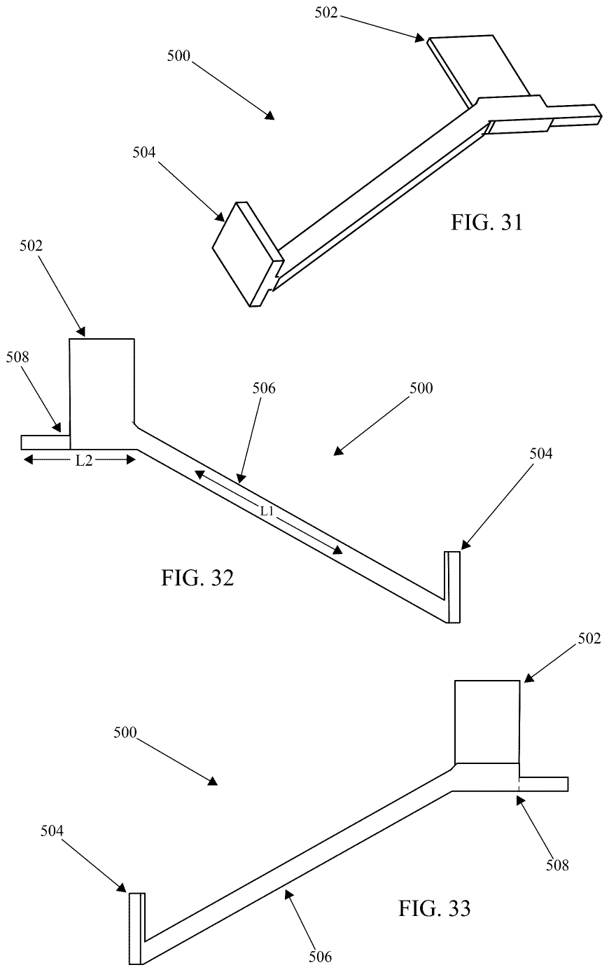

FIG. 31, FIG. 32, and FIG. 33 illustrate a template for mounting window curtain rod 500 configured to facilitate accurate positioning of mounting brackets relative to window trim structures during curtain rod installation applications. The template for mounting window curtain rod 500 provides a positioning and alignment system that enables precise placement of mounting brackets at predetermined distances from window trim elements, ensuring consistent spacing and proper clearance for curtain operation.

The template for mounting window curtain rod 500 comprises a connection tab 502 positioned at one end of the assembly and configured to engage with the vertical slot of a mounting bracket in the same manner as the connection tabs used in the template for mounting shelves 400. The connection tab 502 includes a vertical projection that corresponds to the dimensions of the vertical slot, allowing the connection tab 502 to insert into the vertical slot and establish a mechanical connection with the mounting bracket assembly during positioning and installation.

A window trim block 504 is positioned at a predetermined location within the template for mounting window curtain rod 500 and is configured to contact and align with existing window trim structures during mounting bracket positioning. The window trim block 504 provides a reference surface that corresponds to standard window trim dimensions and profiles, allowing the template for mounting window curtain rod 500 to establish consistent spacing relationships between the mounting bracket and the window trim elements.

A first length-adjustable member 506 extends from the connection tab 502 and spans a first length L1 that defines the primary spacing dimension between the mounting bracket and the window trim block 504. The first length-adjustable member 506 is configured to adjust lengthwise to accommodate different spacing requirements for various window configurations and curtain rod installation applications. The adjustable capability of the first length-adjustable member 506 allows the template for mounting window curtain rod 500 to accommodate different window trim depths and mounting bracket positioning requirements.

A second length-adjustable member 508 extends from the connection tab 502 in a direction perpendicular to the first length-adjustable member 506 and spans a second length L2 that defines a secondary spacing dimension. The second length-adjustable member 508 provides additional positioning reference that accommodates variations in window trim configuration and mounting bracket placement requirements. The perpendicular orientation of the second length-adjustable member 508 relative to the first length-adjustable member 506 creates an L-shaped template configuration that corresponds to typical window trim geometries.

The first length L1 and the second length L2 are independently adjustable to accommodate different window trim configurations and mounting bracket positioning requirements. The first length L1 provides the primary spacing dimension that positions the mounting bracket at the appropriate distance from the window trim to ensure adequate clearance for curtain operation while maintaining proper aesthetic proportions. The second length L2 provides perpendicular spacing reference that accommodates variations in window trim width and mounting bracket positioning relative to the window opening.

The template for mounting window curtain rod 500 functions as a positioning guide that establishes the spatial relationship between the mounting bracket and the window trim structure during installation. The connection tab 502 engages with the vertical slot of the mounting bracket, while the window trim block 504 contacts the existing window trim to establish the reference position. The first length-adjustable member 506 and the second length-adjustable member 508 maintain the predetermined spacing relationships while allowing for adjustment to accommodate different window configurations.

The installation process using the template for mounting window curtain rod 500 begins by positioning the window trim block 504 against the existing window trim structure at the desired location for mounting bracket installation. The first length-adjustable member 506 is adjusted to the first length L1 that provides the appropriate spacing between the window trim and the mounting bracket position. The second length-adjustable member 508 is adjusted to the second length L2 that accommodates the specific window trim configuration and mounting requirements.

The mounting bracket is positioned at the location indicated by the connection tab 502, and the connection tab 502 is inserted into the vertical slot of the mounting bracket to establish the mechanical connection between the template for mounting window curtain rod 500 and the mounting bracket. The template for mounting window curtain rod 500 maintains the mounting bracket position relative to the window trim while the wall fastening screws are installed through the angled holes of the mounting bracket to secure the mounting bracket to the wall.

The window trim block 504 provides consistent reference positioning that accounts for variations in window trim installation and ensures uniform spacing across multiple mounting bracket installations within the same window opening or across multiple windows in the same room. The window trim block 504 contacts the window trim surface and establishes a stable reference point that prevents displacement during the mounting bracket installation process.

The adjustable length capabilities of the first length-adjustable member 506 and the second length-adjustable member 508 allow the template for mounting window curtain rod 500 to accommodate different window trim profiles, including flat trim, beveled trim, and decorative molding configurations. The first length L1 and the second length L2 can be modified to provide appropriate clearance between the curtain rod and the window trim while maintaining proper proportional relationships for aesthetic appearance.

The template for mounting window curtain rod 500 accommodates installation scenarios where multiple mounting brackets are required for a single window opening by providing consistent positioning reference for each mounting bracket installation. The template for mounting window curtain rod 500 can be repositioned along the window trim to establish mounting bracket positions at predetermined intervals, ensuring that the curtain rod will be properly supported across the window span with uniform spacing from the window trim.

The perpendicular configuration of the first length-adjustable member 506 and the second length-adjustable member 508 creates an L-shaped template geometry that corresponds to the typical L-shaped configuration of window trim installations. This geometric correspondence allows the template for mounting window curtain rod 500 to align with both horizontal and vertical trim elements simultaneously, providing comprehensive positioning reference for mounting bracket installation relative to the complete window trim assembly.

After the mounting bracket is secured to the wall using the positioning established by the template for mounting window curtain rod 500, the template for mounting window curtain rod 500 is removed by withdrawing the connection tab 502 from the vertical slot. The mounting bracket remains positioned at the predetermined spacing and alignment established by the template for mounting window curtain rod 500, providing properly positioned mounting points for curtain rod installation that maintain consistent clearance from the window trim structure.

The template for mounting window curtain rod 500 enables accurate positioning of mounting brackets in applications where precise spacing from window trim is required for proper curtain operation and aesthetic appearance. The adjustable length capabilities of the first length-adjustable member 506 and the second length-adjustable member 508 provide flexibility to accommodate different window configurations while maintaining the positioning accuracy provided by the window trim block 504 reference system.

The mounting bracket system accommodates various alternative configurations and material selections that provide flexibility for different installation requirements and application-specific needs. The base plate may be constructed from alternative materials including aluminum alloy, steel, stainless steel, or reinforced polymer compositions depending on load requirements and environmental conditions. Aluminum alloy construction provides reduced weight while maintaining structural strength for residential applications, while steel construction offers enhanced load capacity for commercial or heavy-duty installations. Stainless steel construction provides corrosion resistance for outdoor or high-moisture environments, and reinforced polymer construction offers cost-effective solutions for light-duty applications.

The angled fastening holes may be configured at various angular orientations to accommodate different wall materials and installation requirements. The angled fastening holes may be drilled at angles between 15 degrees and 45 degrees from perpendicular to the wall surface, with specific angles selected based on wall material properties and expected loading conditions. Angles closer to 15 degrees provide increased withdrawal resistance for softer wall materials such as drywall, while angles approaching 45 degrees provide enhanced lateral stability for harder materials such as masonry or concrete. The angular orientation may be customized during manufacturing or adjusted during installation through the use of adjustable cylinder components.

Alternative fastener types may be employed depending on wall material and installation requirements. Threaded wood screws provide direct engagement with wood framing materials, while masonry screws accommodate concrete or brick installations. Toggle bolts or molly bolts may be used for hollow wall installations where access to structural framing is limited. Self-drilling screws eliminate the need for pilot holes in metal stud applications, and expansion anchors provide enhanced holding capacity in solid masonry installations.

The vertical slot configuration may be modified to accommodate different bracket geometries and application requirements. The slot width may be adjusted to accommodate thicker or thinner bracket materials, while the slot depth may be modified to provide different levels of bracket engagement. Multiple parallel slots may be incorporated to accommodate dual-bracket configurations or to provide alternative positioning options for different bracket types. The slot may incorporate internal features such as ridges or detents that provide positive positioning feedback for inserted brackets.

The elongated arch structure may be configured with alternative geometries including rectangular, curved, or tapered profiles depending on aesthetic preferences and structural requirements. The arch may incorporate internal threading to accommodate threaded securing mechanisms, or may include spring-loaded retention features that automatically secure inserted brackets without requiring additional fasteners. Alternative arch materials including flexible polymers or composite materials may provide enhanced vibration dampening for applications subject to dynamic loading.

The reinforcement tabs may be configured in alternative arrangements including single-sided reinforcement, asymmetrical positioning, or integrated fin structures that provide enhanced heat dissipation for applications involving heated curtain rods or shelving systems. The reinforcement tabs may incorporate mounting features for auxiliary components such as cord management systems or decorative elements.

The snap-on facial cover may employ alternative attachment mechanisms including bayonet connections, quarter-turn fasteners, or sliding engagement systems that provide secure attachment while allowing tool-free removal. Magnetic attachment systems may incorporate rare earth magnets for enhanced holding strength, or may use magnetic strips that provide distributed attachment forces across the cover perimeter. Mechanical attachment systems may include spring clips, friction tabs, or cam-operated latches that provide positive engagement with corresponding features on the base plate.

Cover materials may include injection-molded plastics, stamped metal, or composite materials depending on aesthetic requirements and environmental conditions. Textured surfaces may be incorporated to provide visual interest or to match existing architectural elements, while smooth surfaces may be selected for easy cleaning and maintenance. The cover may incorporate integrated lighting elements, decorative patterns, or color-matched finishes that coordinate with interior design schemes.

The mounting bracket system may be scaled to accommodate different load requirements and application sizes. Miniature versions may be configured for lightweight applications such as small decorative shelves or cafe curtains, while heavy-duty versions may incorporate enlarged base plates and additional fastening points for commercial shelving or industrial curtain systems. The vertical slot dimensions may be proportionally adjusted to accommodate corresponding bracket sizes while maintaining proper engagement characteristics.

Alternative upper extending tab configurations may include single-tab designs for simplified installations, or multi-tab arrangements that provide additional fastening points for enhanced load distribution. The tabs may incorporate integrated cable management features, mounting points for auxiliary hardware, or decorative elements that enhance the visual appearance of exposed installations.

The bottom portion may be configured with alternative fastening arrangements including single-point attachment for simplified installations, or distributed fastening patterns that accommodate specific wall stud spacing or masonry joint configurations. The bottom portion may incorporate leveling features such as adjustable feet or shim accommodation that compensate for wall irregularities during installation.

Template systems may be configured for specific application requirements including adjustable templates for custom spacing applications, fixed templates for standard shelf or curtain rod configurations, or modular template systems that accommodate multiple mounting bracket installations simultaneously. The templates may incorporate digital level indicators, laser alignment systems, or integrated measuring devices that enhance installation accuracy and reduce setup time.

The mounting bracket system may be adapted for specialized applications, including ceiling-mounted configurations for overhead curtain tracks, corner-mounted arrangements for bay window installations, or pivoting configurations that allow for adjustable curtain rod positioning. These adaptations may incorporate modified base plate geometries, alternative fastening arrangements, or specialized hardware that accommodates the specific mounting requirements of each application type.

Features of any of the examples or embodiments outlined above may be combined to create additional examples or embodiments without losing the intended effect. It should be understood that the description of an embodiment or example provided above is by way of example only, and various modifications could be made by one skilled in the art. Furthermore, one skilled in the art will recognize that numerous further modifications and combinations of various aspects are possible. Accordingly, the described aspects are intended to encompass all such alterations, modifications, and variations that fall within the scope of the appended claims.

1. A mounting bracket for supporting an L-shaped bracket, comprising:
a base plate having a rear surface for mounting to a wall and a front surface;
first and second upper extending tabs extending from an upper portion of the base plate, the first and second upper extending tabs defining first and second angled holes oriented at downward angles for receiving fasteners;
a bottom portion of the base plate defining third and fourth angled holes oriented at upward angles for receiving fasteners; and
a vertical slot formed in the base plate and configured to receive and support the L-shaped bracket.

2. The mounting bracket of claim 1, wherein the first and second angled holes are defined by first and second angled cylinders extending outwardly and upwardly from the front surface, and wherein the third and fourth angled holes are defined by third and fourth angled cylinders extending outwardly and downwardly from the front surface.

3. The mounting bracket of claim 2, further comprising first and second reinforcement tabs integrated with the front surface and positioned at opposite sides of the vertical slot.

4. The mounting bracket of claim 1, wherein the first, second, third, and fourth angled holes are oriented at angles between 15 degrees and 45 degrees from perpendicular to the rear surface.

5. The mounting bracket of claim 1, further comprising an elongated arch structure attached to the front surface and defining the vertical slot.

6. The mounting bracket of claim 5, wherein the elongated arch structure includes at least one securing hole configured to receive a securing screw for retaining an L-shaped bracket within the vertical slot.

7. The mounting bracket of claim 1, wherein the rear surface comprises a flat surface configured for flush contact with the wall.

8. A mounting bracket system comprising:
a mounting bracket according to claim 1, wherein the first, second, third, and fourth angled holes are defined by angled cylinders extending outwardly from the front surface; and
a snap-on facial cover configured to attach to the front surface of the base plate and conceal components of the mounting bracket while maintaining access to the vertical slot.

9. The mounting bracket system of claim 8, wherein the snap-on facial cover comprises an exterior wall and a perimeter wall extending rearward from the exterior wall.

10. The mounting bracket system of claim 8, wherein the snap-on facial cover includes an upper entrance and a lower entrance aligned with the vertical slot.

11. The mounting bracket system of claim 8, wherein the snap-on facial cover includes a magnet for securing the cover to the base plate.

12. The mounting bracket system of claim 8, comprising a plurality of mounting brackets spaced apart from each other and configured to collectively support a curtain rod.

13. The mounting bracket system of claim 8, further comprising wall fastening screws extending through the angled holes, wherein screws extending through the first and second angled holes are oriented at downward angles and screws extending through the third and fourth angled holes are oriented at upward angles to create opposing force vectors.

14. A mounting kit comprising:
a mounting bracket system according to claim 8, wherein the angled cylinders extend at angles between 15 degrees and 45 degrees from perpendicular to the rear surface, and wherein the snap-on facial cover includes attachment means for securing to the base plate; and
a template system comprising a length-adjustable member, connection tabs configured to engage vertical slots of multiple mounting brackets, and a level indicator for alignment during installation.

15. The mounting kit of claim 14, wherein the template system includes a first connection tab positioned at a first end of the length-adjustable member and a second connection tab positioned at a second end of the length-adjustable member.

16. The mounting kit of claim 14, wherein the level indicator comprises a bubble level integrated into the length-adjustable member.

17. The mounting kit of claim 14, wherein the template system further comprises a window trim block configured to contact window trim for positioning the mounting brackets relative to the window trim.

18. The mounting kit of claim 14, wherein the template system comprises a first length-adjustable member and a second length-adjustable member extending perpendicular to the first length-adjustable member.

19. The mounting kit of claim 14, wherein the connection tabs are configured to insert into the vertical slots of the mounting brackets to establish mechanical connections during installation.

20. The mounting kit of claim 14, wherein the template system is configured to maintain a predetermined spacing between multiple mounting brackets during installation.
